(19) United States
(12) Patent Application Publication
(10) Pub. No.: US 2005/0060189 A1
(43) Pub. Date: Mar. 17, 2005

(54) Methods and system for bio-intelligence from over-the-counter pharmaceutical sales

(76) Inventor: Xiaohui Zhang, Tucson, AZ (US)

Correspondence Address: SCIENTIFIC TECHNOLOGIES CORPORATION, 4400 E BROADWAY BLVD, SUITE 705, TUCSON, AZ, 85711, US

(21) Appl. No.: 10/662,552

(22) Filed: Sep. 15, 2003

(51) Int. Cl. G06F 7/60; G06F 17/10; G06F 17/60

(52) U.S. Cl. 705/2; 703/2

(57) ABSTRACT

An analysis and unusual event detection method is presented herein that was developed systematically for bio-intelligence in the area of syndromic surveillance using over-the-counter (OTC) pharmaceutical sales data. First, a measurement scheme was defined. It bases on historical sales records and a set of derived seasonally varying reference lines. The relative deviation (RD) of the current daily medicine sales data from the reference lines, the n-days cumulation of the relative deviations, and the daily change of the relative deviations are calculated. Second, a dynamic system model for categorized public health status was developed and described by a set of state variables and state transitions. State transitions are determined by a rule system. The combination of the quantitative measurements listed above establishes the supporting set for the rule system. Therefore, the dynamic change of public health status is systematically modeled over time and space by rule-system-driven state transitions. Certain system states represent unusual events and can be fully described through this methodology.

### RELATED APPLICATIONS

None.

### STATEMENT REGARDING FEDERALLY SPONSORED R & D

The research presented herein has not been sponsored with federal funds.

### BACKGROUND OF THE INVENTION

Recently, a few pharmaceutical sales surveillance systems have been developed for monitoring public health status. Those systems count the number of sales of categorized medical items, and plot those values over time. Public health experts need to review the trend of categorized medicine sales, map it into a relationship with the public health status, and do data interpretation. Those systems have no functionalities to directly detect unusual public health events before the clinical diagnosis is performed or to directly explain the relationship to public health status through OTC medicine sales data. Because of the above reasons, the detection of unusual public health events and the identification of public health status usually is delayed until a time when the number of patients seeking professional medical help reaches an abnormal level, and the number of confirmed disease cases is above a pre-defined threshold value. This means many people have already been infected, sometimes even the secondary spread of a communicable disease would be underway.

As there is a rise in threats from emerging infectious diseases and a degradation in the quality of the environment, there is an urgent need for a method and system with automated processes to detect unusual public health events faster and more efficiently than through the clinics. This early detection could greatly aid public health workers and even save peoples' lives. Methods and systems with the capacity to systematically identify the public health status from the varying OTC medicine sales data and other early indicators could greatly benefit public health for disease prevention and control. It will also help pharmacy stores in planning and inventory control incorporating the seasonal adjustment.

The system and methods presented herein integrate database technologies, knowledge based techniques, statistical analysis methods, dynamic systems theory and rule systems. The system is an integrated decision support system designed for both the public health and pharmaceutical industry.

Herein, the applied database technology is used for the replicated sales data repository, utilized in organizing the processed data, and for querying and retrieving information. Additionally, the knowledgebase technique approach is utilized in deriving knowledge from data processing, then storing and organizing the knowledge in multiple dimensions along space and time, followed by inference utilizing the rule systems.

The state-space form, as a part of the mathematical system theory (Kalman et al 1969), is adapted here in modeling categorized public health status. A category of the public health status, for example, can be the gastrointestinal disease syndrome, the respiratory disease syndrome, or the children flu like diseases. A set of state variables are defined here to represent the categorized public health status, and the state transition mechanisms are developed for modeling the change of public health status over time. The major difference in this described modeling of state transitions presented from the conventional ones is that the transitions here are governed by rule systems. The rule systems evaluate the states and the inputs then make the decision; while in the other systems the state transitions are determined by an explicit algebra function, for example, linear algebra in most cases.

A rule system is a set of rules, arguments, constraints, relations, and responses. A rule can be numerical, logical or both. A hybrid rule system consists of both explicit functions and logical rules. The presented system is a hybrid rule system.

There are no publications found for an OTC pharmaceutical sales surveillance system that include knowledge acquisition on public health. Additionally, up to now, no publication is found for a state-space model with state transitions determined by rule systems in the public health area.

### BRIEF SUMMARY OF THE INVENTION

The present invention relates to a method and system for monitoring public health status with information technology, and more particularly to the early detection of unusual public health events through the analysis of the over-the-counter (OTC) pharmaceutical sales data. The present invention could be directly applied to the implementation of public health decision support systems in the area of bio-intelligence. Another direct application of this invention could be pharmaceutical supplies planning and inventory. A potentially useful application is in providing the workload adjustment for the public health systems and pharmaceutical industries.

### BRIEF DESCRIPTION OF THE DRAWINGS

A number of drawings (figures, table, and equations) have been used to illustrate the principles of the invention and its computational methods.

Figures

FIG. 1 shows the examples of the categorized OTC daily sales in three months from both last year and this year in the same study area;

FIG. 2 shows the derived reference lines from the historical data set with equation (1), (2) and (3), here they are from the last year's data;

FIG. 3 is a graph of three structural components computed by equation (4), (5) and (6);

FIG. 4 illustrates how to derive the confidence supporting set for Component 1 by equation (7);

FIG. 5 illustrates how to derive the confidence supporting set for Component 2 by equation (8);

FIG. 6 illustrates how to derive the confidence supporting set for Component 3 by equation (9);

FIG. 7 is the diagram of defined state variables and the validated state transitions;

FIG. 8 is the example to illustrate the rule system by using the transformed results of incoming OTC daily sales.

FIG. 9 is the example of the OTC sales abnormality analysis in supporting the risk assessment and management. The map displays the derived service areas, the area population density, and the categorized OTC sales analysis.

### TABLES

Table 1 shows the validated state transitions.

Equations

Equation (1) defines the calculation of the central reference line at a specified place.

Equation (2) defines the calculation of the deviation from the central reference line.

Equation (3) defines the calculation of the upper reference line.

Equation (4) defines the calculation of the relative deviation of the incoming daily data from the central reference line.

Equation (5) defines the calculation of the n-days-cumulated-deviation of the incoming data from central reference line.

Equation (6) defines the calculation of the change of the relative deviation.

Equation (7) defines the confidence supporting set of the first component.

Equation (8) defines the confidence supporting set of the second component.

Equation (9) defines the confidence supporting set of the third component.

Equation (10) defines the system state transitions and the measurement of the state.

Equation (11) defines the system input mapping from the supporting sets and their threshold values are incorporated.

Equation (12) defines the system outputs are mapped from the state history and the background information can be incorporated.

Equation (13) defines the supporting space.

Equation (14) defines the supporting system is an additive combination of supporting sets.

Equation (15) defines the values of an output are the combination of a likelihood index, a trend indicator and a potential impact index.

### DETAILED DESCRIPTION

The invention consists of the mathematical model describing the change of categorized health status, and more importantly it has the detection methods for unusual health status before evidence appears in clinics, and a dynamic model for the change of a categorized public health status from OTC medicine sales at a specific location. First, the measurement scheme is defined. Then, at a specified place, reference lines are established from historical data. Those reference lines represent the normal values and extreme values of the OTC daily sales during a particular time interval at a specific location. Current daily values, for the same category, are measured by their deviations from the reference lines. Measurements include the relative change, the n-days-cumulated change and the rate of the changes.

The Measurement of the OTC Medicine Daily Sales at a Place and a Time

A study place can be a store service area, a zip-code area, a city, a county or it can be statewide. The approach is the same for all the areas. Here, to simplify the description, we just state it as ‘a study area’ or ‘at each geographical level’.

A time unit can be a day, a week, a month, a season, or simply x-number of days. The approach is the same for all time units. Here, to simplify the description, we just state it as ‘a time unit’.

Calculations of the Reference Lines

The main purpose of this method is to detect the irregular change of public health status from the regular change of OTC sales. First, the m-years-historical data, from the current date back to at least one previous year, are processed to derive the reference lines. Next, a time unit is defined for the specified time interval, the averaged time-unit-value is calculated for each category as equation (1) at each geographical level. For example, it could be a monthly-averaged-daily-value for the medicines for gastrointestinal symptoms for each city. Similarly, the standard deviation of the daily sales is calculated by equation (2), and the confidence interval upper limit of the mean is calculated by equation (3). The results of those three equations could yield the center and the upper reference lines at each corresponding geographical level. Since it is computed in each time interval, the seasonal variations of disease syndromes are maintained; and the computations at each location in different geographical levels portrait the spatial characteristics. For a specified place, the calculations are performed as equation (1), (2) and (3).

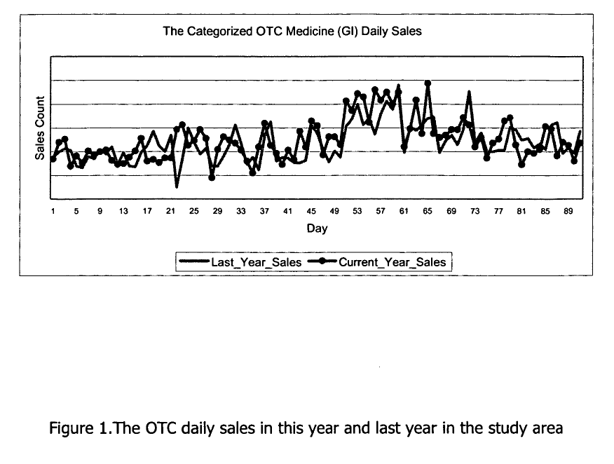

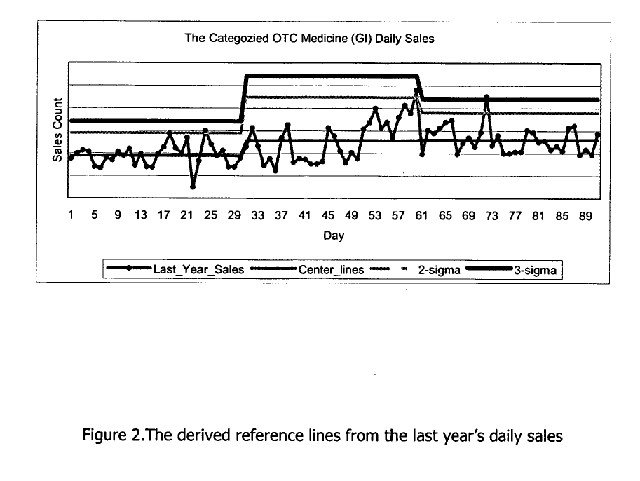

Equation (1) yields the center reference line or baseline, while equation (2) and equation (3) yield the upper reference lines, for example, they could be 2-sigma and 3-sigma lines when tₘₓₙ₋₁=2 and 3. To illustrate the usage of equation (1) to (3), a sample set of The OTC data are plotted in FIG. 1. The sample data are the daily OTC sales related to gastrointestinal diseases, three-month long, both in last year and in this year at a study area. For the non-disclosure of business data, the sales amounts are not displayed in the graph. FIG. 2 shows the derived monthly reference lines from the sample data in last year, based on equation (1) to (3).

To measure the change of OTC sales at a specified place, or possibly the abnormality, the following equations define three structural components derived from the time-unit sales data. In the following example, the time-unit is daily. The first structural component is defined by equation (4). In a specified place, Equation (4) is the measurement of the relative deviation for daily sales from the center reference line, which is the averaged-daily-value in that time interval and it stands for a normal status unless there was a record of a large-scale outbreak that had happened in the past used to calculate this reference line. Using the calculation in equation (4), if m is small (less than three), there is no requirement for the population data in the specified area unless there is a significant change of the population in one or two years at that place. This is another advantage of this approach.

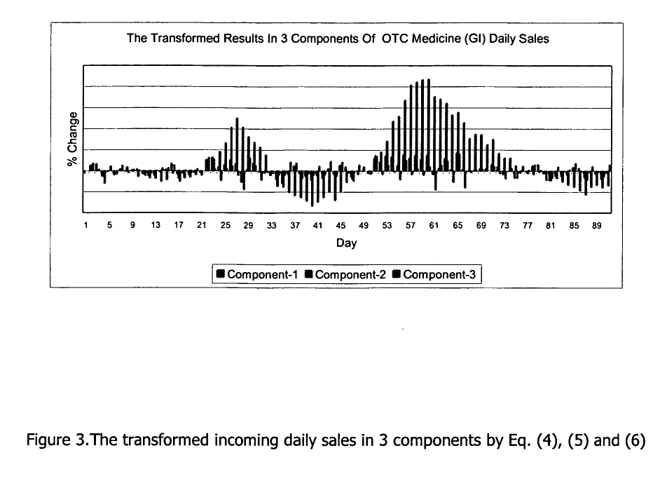

The second component is defined by equation (5), it is the n-days-cumulated-change of the categorized OTC daily deviation from the baseline. The example shows the 7-days when n is from 0 to 6. By defining n is greater than 6, Equation (5) smoothes the sales variation in weekdays and on weekends. The physical meaning in Equation (5) is that most of the time the purchased medicine is used in several days, thus, its effects remain for several days. In the application, the value of n is also determined by the categorized medicines. Equation (6) reflects the daily change of the relative deviation, it is a leading indicator of the trend, and this is the third structural component. In the equation, L denotes the current year. The calculated results from Equation (1), (2), (3), (4), (5) and (6) quantitatively describe the historical daily sales in a normal situation, and the differences of current daily sales from it and the change of those differences. Those calculated results are the base of the supporting sets for the input rule system. FIG. 3 illustrates the transformed results by using the same sample data set plotted in FIG. 1, based on the equation (1), (4), (5) and (6).

The confidence supporting sets of above components, (d, w, v,), are defined from the cumulated distribution functions as shown in equation (7), (8) and (9).

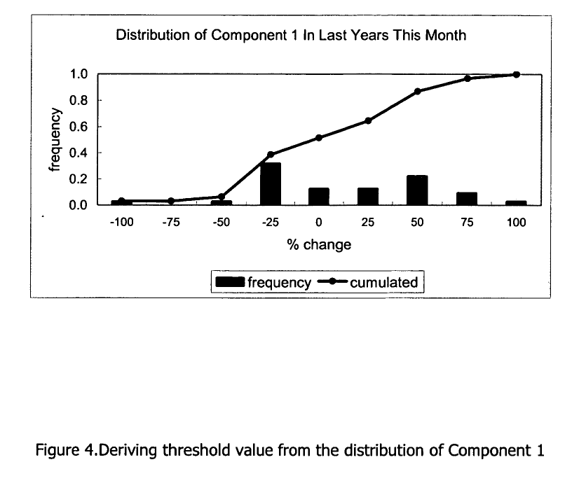

For example, if a=0.05 is specified for month j at a study place, then in the historical data set where years are (I<L), the cumulated distribution function F(d_{I<L,j,i}) is structured first; next, the supp((α(k)) is found as the set of d_{I<L,j,i} such that its cumulated distribution function F(d_{I<L,j,i})>(1-0.05). Similarly equation (8) and (9) define the confidence supporting sets of the other two components, and FIG. 4 to FIG. 6 illustrate them graphically.

A Dynamic Model of the Categorized Public Health Status

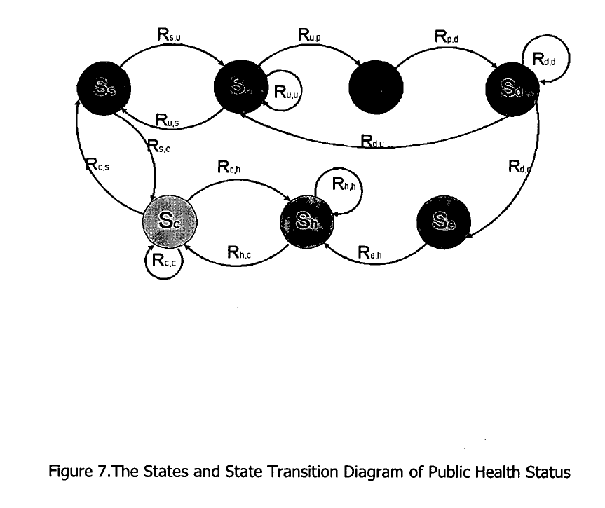

The dynamic change of the public health status with space and time is modeled here in a new state-space form. This newly invented state-space form differs from the other conventional state-space approach in that here the state transition, input mapping and output mapping are governed by the rule systems; while the conventional state-space form uses crisp algebra or linear algebra in most cases. With a state space notation, at a specified place, the categorized public health status is explicitly modeled by a set of state variables, which are varying over time. Defined by this model, at a specific time, a categorized health status is one of the following: healthy status (Sₕ), critical status (S_{c}), starting-unusual status (S^{s}), upward-trend-unusual status (Sᵤ), peak-unusual status (Sₚ), downward-trend-unusual status (S_{d}), and ending-unusual status (Sₑ). The state transitions over the time reflect the dynamic change of the public health status. The state space S is defined with its state variables {S: Sₕ, S_{c}, Sₛ, Sᵤ, Sₚ, S_{d}, Sₑ}. A validated state transition from state Sᵢ(k) to state Sⱼ(k+1) is determined by the rule systems which operate in relational algebra on its supporting set Xᵢ(k). The validated state transitions are defined in FIG. 7 with the arrow arcs, or by Table 1. In Table 1 a zero stands for an invalidated transition, while the validated transition from state Sᵢ(k) to state Sⱼ(k+1) is determined by a rule base R_{i,j}, which evaluates the inputs Xᵢ(k) at state Sᵢ(k).

Since in most cases we work on the daily base in the current year, to simplify the notation, the subscript ‘L’ (which stands for current year) is omitted in the following equations.

Equation (10) defines the general form of state transitions from a state Sᵢ(k) to another state Sⱼ(k+1), and the transition is determined by a rule system R_{i,j} operating on the supporting set of Xᵢ(k). The quantitative measurement of the state Sᵢ(k) is also defined by Equation (10).

As time advances, for example a time unit can be daily, the state transition from state Sᵢ(k) to state Sⱼ(k+1) is determined by the rule system R_{i,j} which evaluates the supporting set Xᵢ(k), as shown in Equation (10), where \mathring{X} stands for the inference operation, or a rule system operation, which can be logical operations or algebra operations or mixture of them. Equation (10) also defines the value of a state Sᵢ(k) is proportional to the n-days-cumulated deviation in that category at the specified place. The k_{w} can be defined from the supporting set data, for example it can be related to the threshold value obtained from the historical data set.

Equation (11) describes that, at a state Sᵢ(k), there is the supporting set Xᵢ(k) with 3 structural components, and their thresholds (α(k), β(k), δ(k)) can be incorporated and the rule system B_{i,m} maps the components into supporting set X(k). Where \mathring{X} stands for the inference operation, or a rule system operation.

Equation (12) describes the output mapping, which interprets the outputs from a set of states or a state history with the specified weight for the states by {γ₀(k), γ₁(k), . . . , γₙ(k)}. In addition, the rule system combines the background information, Gᵢ, such as the environment factors, the population or the age grouped population in the study area.

Equation (13) and (14) define the supporting system X is an additive combination of supporting sets. It means the inputs can be multiple data sources.

Equation (11), (12) and (13) together define the thresholds of the supporting sets. The threshold values are derived from the historical data in the same time interval (e.g. the jth month in past m years), for the time unit i(e.g. the ith day), for each component. In equation (11), (12) and (13), the supporting sets are derived from the cumulated probability distributions, F_{d}(α), F_{w}(β) and Fᵥ(δ), of the three components.

Equation (15) defines that the value of an output is the combination of the likelihood index of abnormality (Q_{i, h}), the trend indicator (T_{i, h}) and the potential impact index (P_{i,h}). As an example they have been defined here as
{Q_{i, h}: (low, medium, high)},
{T_{i, h}: (stable, upward, downward)},
{P_{i, h}: (minor, moderate, significant)}.

For example, a Yᵢ=(Q_{i,2}, T_{i,2}, P_{i,3}) stand for the medium likelihood abnormality, with upward trend status and possible significant potential impact. In reality, this situation might require specified extensive management. In the case where the population density is used to describe the potential impact, Pᵢ is defined as (light density, low density, high density).

The following example is the best mode presently contemplated for carrying out the invention. This description is not to be taken in a limiting sense, but is made merely for the purpose of describing the principles of the invention. The scope of the invention should be determined with reference to the claims. In this example, the OTC sales data has one-year historical records. To make it easier to illustrate, the study geographical area is the store service area which is estimated by the driving distance; and the time unit is daily, the time interval for the computation of reference lines is 30 days, the plotted time period is 91 days (date converted to Day 1 to Day 91), which actually were data from three different months. For the purpose of non-disclosing the real sales data, the sales counts are not displayed in the following examples.

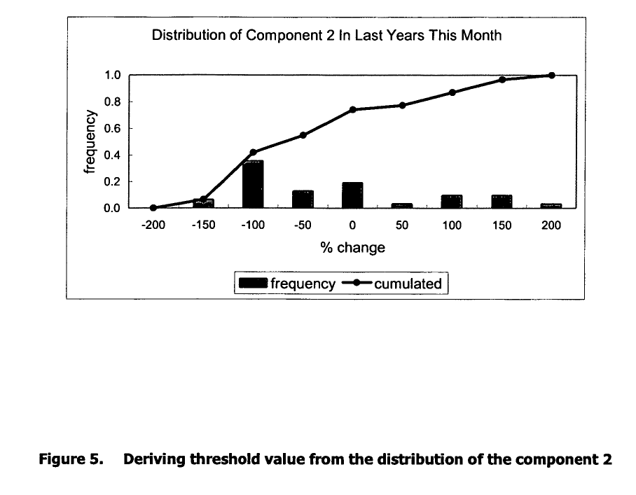

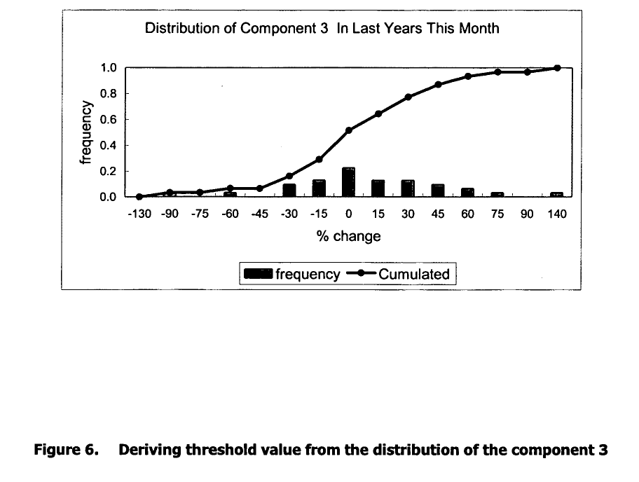

The distribution of structural component 1 for the same month last year can be used to derive the threshold value for d_{i,1}(k). For example, if an α-level is set as α(k)=0.05, then the α-support of X_{i,1}(k)=75% by equation (11). Similarly, FIG. 5 and FIG. 6 are illustrations of deriving threshold values for Component 2 and Component 3 by equation (12) and equation (13).

Summary

The invented dynamic system model and the data analysis methods have been described. The measurement scheme is defined first. The reference lines are derived from the historical data at the same geographical unit. Next, the incoming data are transformed into three structured components as defined by equation (4), (5) and (6). The dynamic system model for public health status was developed in the form of state space as equation (10), (11) and (12). There are seven state variables are defined, with the validated state transitions in Table 1. The state transitions are determined by the rule systems. The system supporting sets are compiled from the transformed incoming data, while the system outputs are mapped from the state variables' history and possible other data sources.

An Example of the Change of Categorized Health Status as State Transitions with the Rule System Operations

To further illustrate the method and system disclosed here, the examples of the state transitions, and rule systems operations are provided. Those examples are not the complete rule operations, but merely used for the purpose of illustration.

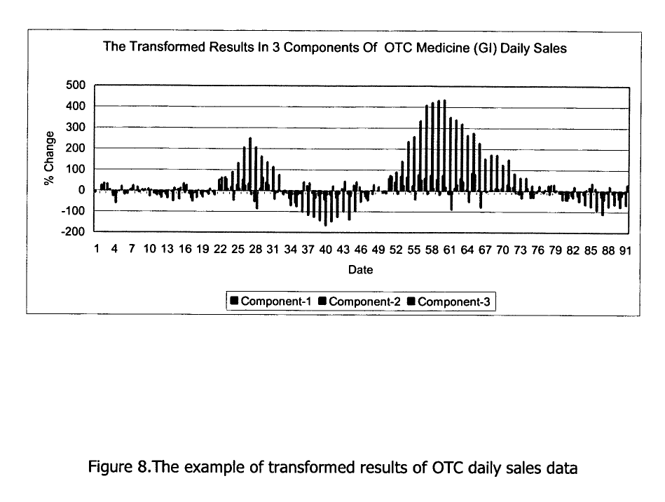

The example data set is the daily OTC medicine sales of gastrointestinal (GI) diseases in a studied area, with one year's historical data. The base line is computed by equation (1), and transformed three structural components by equation (4), (5) and (6). FIG. 8 displays the transformed daily OTC medicine sales of gastrointestinal diseases in the studied area. The data from Day 33 to Day 77 are taken to illustrate the defined state transitions for the estimation of public health status in the category of gastrointestinal diseases in the studied place.

In this example, the α-level is set as 0.05, thus, the threshold values for three components are 75%, 150% and 70% (corresponding to FIGS. 4, 5 and 6). Here the coefficient k_{w} in equation (10) is defined in reference of the threshold value. Thus,
K_{w}=1/150.

Based on equation (10) to equation (15), the system state transitions from Day 33 to Day 77 can be summarized as the followings.
Day 33 to Day 50, the status in state Sₕ(k; k=33, . . . , 50) (healthy status);
Day 51 the state transited to state S_{c}(51) (critical status);
Day 52 the state transited to Sᵤ(52) (starting unusual status);
Day 53 the state transited to Sᵤ(53) (upward trend unusual status), and it is above the threshold value of w(k);
Day 54 to Day 55, the states are Sᵤ(k; k=54, 55) (upward trend unusual status);
Day 56 the states in Sᵤ(56) (upward trend unusual status) and the component 1 is above the threshold value of α(k);
Day 57 to Day 59, the states are Sᵤ(k; k=57, . . . , 59) (upward trend unusual status);
Day 60 the state is Sₚ(60) (peak in the unusual);
Day 61 to Day 64 the states in S_{d}(k; k=61, 62, . . . , 64)) (downward trend unusual);
Day 65 the states in S_{d}(65) (downward trend unusual) while component 1 is above the threshold value of α(k);
Day 66 to Day 71 the states in S_{d}(k; k=66, 67, . . . , 71)) (downward trend unusual);
Day 72 the states in S_{d}(72) and it is below the threshold value of w(k);
Day 73 to Day 75 the states in S_{d}(k; k=73, 74, 75)) (downward trend unusual);
Day 76 the state is Sₑ(76) (ending unusual);
Day 77 the state back to Sₕ(77) (healthy status).

To further illustrate the method and system disclosed here, some examples of the state transitions with the rule system operations are provided. Those examples are not the complete rule operations, but merely used for the purpose of illustration. In the following example, the output's potential impact index is assumed ‘moderate’, P_{i,2}.

### EXAMPLES OF STATE TRANSITION AND INPUTS/OUTPUTS WITH DATA REFERENCED IN FIG. (5) TO (8)

Day 33 to Day 50, the status in state Sₕ(k; k=33, . . . , 49) (the healthy status):

| | |
|---|---|
| R_{i,j} : | If S(k−1) = Sₕ |

and

{ wᵢ(k−1) < 0 }

then

S(k) => Sₕ and its value is Sₕ(k) = k_{w} wᵢ(k) < 0.

| | |
|---|---|
| H_{i,n}: | If max{S(k), S(k−1), .., S(k−n)} < 0, |

Then

Y(k) = (Q_{i,1}, T_{i, 1}, P_{i, 2}).

Day 51 the state transited to state S_{c}(51) (a critical status):

| | |
|---|---|
| R_{i,j} : | if S(k−1=50) = Sₕ |

And
{dᵢ(k) ∈ supp(α(k)) and vᵢ(k) ∈ supp(δ(k))}

then

S(k=51) => S_{c}, and its value is S_{c}(k) = k_{w} wᵢ(k) = 0.5.

| | |
|---|---|
| H_{i,n}: | If {S(k−1), .., S(k−n)} = Sₕ |

And S(k) = S_{c}

Then

Y(k) = ( Q_{i,2}, T_{i, 2}, P_{i, 2}).

Day 52 the state transited to Sₛ(52) (starting unusual status):

| | |
|---|---|
| R_{i,j} : | if S(k−1=51) = S_{c} |

And
{dᵢ(k) ∈ supp(α(k)) and wᵢ(k) ∈ supp(β(k))}

then

S(k=52) => Sₛ, and its value is Sₛ(k) = k_{w} wᵢ(k) = 0.65.

| | |
|---|---|
| H_{i,n,}: | If {S(k−1)} = S_{c} |

And S(k) = Sₛ

Then

Y(k) =( Q_{i,2}, T_{i, 2}, P_{i, 2}).

Day 52 to Day 59, the states are Sᵤ(k; k=52, . . . , 59) (upward-trend in unusual status):

| | |
|---|---|
| R_{i,j} : | if S(k−1=52) = Sₛ |

And {

{ dᵢ(k) ∈ supp(α(k)) and wᵢ(k) ∈ supp(β(k)) }

or
{ dᵢ(k) ∈ supp(α(k)) and v₃(k) > 0 }

}

then

S(k) => Sᵤ, and its value is Sᵤ(k) = k_{w} wᵢ(k) (greater than 1.0).

| | |
|---|---|
| H_{i,n}: | If {S(k−1)} = ( S_{c} or Sᵤ ) |

And S(k) = Sᵤ

Then

Y(k) =( Q_{i,3}, T_{i, 2}, P_{i, 2}).

(Note: at k=53, wᵢ(k) reaches the threshold value, this issues an alert in the application.)

Day 61 to Day 75 the states in S_{d}(k; k=61, 62, . . . , 75)) (downward trend unusual):

| | |
|---|---|
| R_{i,j} : | if S(k−1) = Sₚ or S_{d} |

And {

{ dᵢ(k) < 0 or vᵢ(k) < 0 }

or

{ dᵢ(k) ∉ supp(α₁(k)) or vᵢ(k) ∉ supp(β₁(k)) }

}

then

S(k) => S_{d}, and its value is S_{d}(k) = k_{w} wᵢ(k).

| | |
|---|---|
| H_{i,n}: | If {S(k−1)} = ( Sₚ or S_{d} ) |

And S(k) = S_{d}

Then

Y(k) = =( Q_{i,2}, T_{i, 3}, P_{i, 2}).

Day 76 the state is Sₑ(76) (ending unusual):

| | |
|---|---|
| R_{i,j} : | if S(k−1) = S_{d} And |
| | { wᵢ(k) < or wᵢ(k) = 0 } |

then

| | S(k) => Sₑ, and its value is Sₑ(k) = k_{w} wᵢ(k). |
|---|---|
| H_{i,n}: | If {S(k−1)} = ( S_{d} ) |
| | And S(k) = Sₑ |
| | Then |

Y(k) = =( Q_{i,1}, T_{i, 1}, P_{i, 2}).

Day 77 the state transitioned back to Sₕ(77) (healthy status):

| | |
|---|---|
| R_{i,j} : | if S(k−1) = Sₑ or Sₕ And |
| | { wᵢ(k) < 0 or wᵢ(k) = 0 } |

then

| | S(k) => Sₕ, and its value is Sₕ(k) = k_{w} wᵢ(k). |
|---|---|
| H_{i,n}: | If {S(k−1)} = ( S_{d} or Sₑ ) |
| | And S(k) = Sₕ |

Then

Y(k) = ( Q_{i,1}, T_{i, 1}, P_{i, 2}).

### EXAMPLE OF THE SYSTEM OUTPUTS WITH A GIS MAP

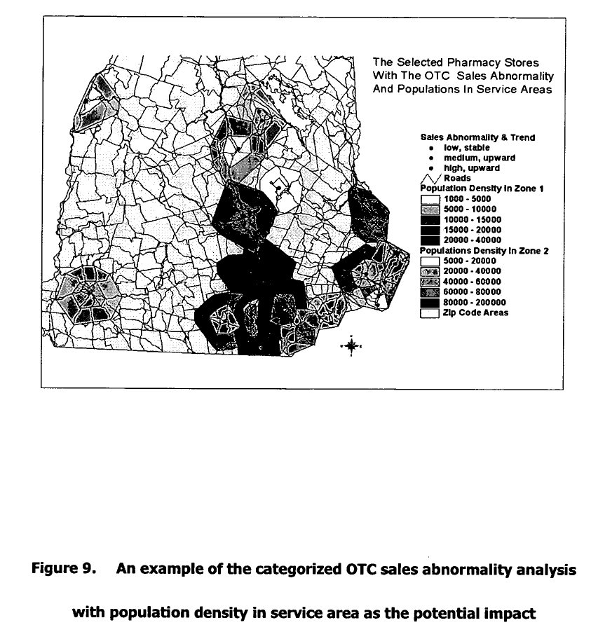

The system outputs as described above contain the information of the likelihood of abnormality and the potential impact indicators. The estimated likelihood abnormality is mapped to the health status in the studied area. As an example, the service areas are derived with the driving distance within 5 minutes and 10 minutes to the stores, and the populations within the service areas are the part of the referenced potential impacts. By using geographical information systems (GIS) with the application of the disclosed methods, FIG. 9 is the example that displays the spatial distributions of the likelihood of abnormality and potential impacts. In FIG. 9, the abnormality is classified as ‘low, stable’ for outputs are the likelihood is low and the trend is stable; similarly the ‘medium, upward’ is for likelihood is medium and trend is upward, and ‘high, upward’ for likelihood is high and trend is upward. Through the overlay of the OTC sales abnormality with the population density in the service area, a combined output is obtained, FIG. 9 is a map display of equation (12).

Disclaimer

While the invention herein disclosed has been described by means of specific applications thereof, numerous modifications and variations could be made thereto by those skilled in the art without departing from the scope of the invention set forth in the claims.

References

Topics in Mathematical Systems Theory

Kalman, R. E., Falb, P. L., Arbib, M. A. (1969), McGraw-Hill Book Company

Linear System Theory, The State Space Approach

Zadeh, Lofti A., Desoer, Charles A. (1963), McGraw-Hill Book Company

1. A system for detecting an unusual public health status and for modeling the change of categorized public health status from over-the-counter (OTC) pharmaceutical sales data, comprising:
A measurement scheme defined by a set of variables and calculations of categorized daily OTC sales data in a specified geographical scale,
An algorithm for unusual public health status (or event) detection incorporating seasonally varying reference lines, and calculating three structural components from the input data: a daily deviation from the reference line, an n-days-cumulated-deviation, and the change of the daily deviations in that area,
A dynamic system model describing the categorized public health status by a set of state variables, and the change of the health status by the state transition, the input sets, the output sets, and the rule systems that govern them,
The rule system determines the state transitions for modeling the dynamic change of public health status through the analysis of information derived from OTC pharmaceutical sales in that area,
A rule system combines the structural components incorporating the confidence supporting sets as the input variables,
A rule system maps the state history to the output variables.

2. The apparatus as claimed in claim 1, wherein said measurement scheme includes the calculation of monthly (or weekly, or daily, or seasonally) averaged daily sales for the categorized OTC medicines as the base line, from the data in the past at the same place, which is one data set (base line) for supporting the rule system.

3. The apparatus as claimed in claim 1, wherein said measurement scheme includes the calculation of the deviation of daily sales in the current-month from the base line, and it is measured in change of percentage at the same place, which is another data set (the first structural component) for supporting the rule system.

4. The apparatus as claimed in claim 1, wherein said measurement scheme includes the calculation of the n-days-cumulated-deviation, which is another data set (the second structural component) for supporting the rule system.

5. The apparatus as claimed in claim 1, wherein said measurement scheme includes the calculation of the daily change of the deviation, which is another data set (the third structural component) for supporting the rule system.

6. The apparatus as claimed in claim 1, wherein said event detection algorithms are a rule system with supporting sets from the results in claim 2, 3, 4 and 5.

7. The apparatus as claimed in claim 1, wherein said dynamic model of the categorized public health status is defined by the system with a set of state variables and state transitions over the time dimension at a specified place, with which state transitions model the change of the categorized public health status.

8. The apparatus as claimed in claim 7, wherein said set of state variables are healthy status, critical status, starting-unusual status, upward-trend-unusual status, peak-unusual status, downward-trend status, and ending-unusual status.

9. The apparatus as claimed in claim 1 and claim 7, wherein said state transitions over time at a specified place are the mathematical descriptions on how the categorized health status changes from one state to another state as time advances. The example time unit is daily.

10. The apparatus as claimed in claim 1, wherein said input sets are the supporting sets for the state transition rule systems; it is mapped from the structural components incorporating the confidence levels.

11. The apparatus as claimed in claim 10, wherein said input sets are the supporting sets for the state transition rule systems and are mapped from the structural components incorporating the confidence levels, where the confidence levels are derived from the historical data sets, and the confidence supporting sets are found from the cumulated distribution functions with the specified confidence levels.

12. The apparatus as claimed in claim 1, wherein said output sets are a set of vectors, each with three values: likelihood, trend indicator, and impact indicator, where the output sets are mapped from the state history at the study place.

13. The apparatus as claimed in claim 1, wherein said rule system that governs the state transitions is the system with sets of logical rules, which evaluate both the logical and numerical functions to determine the system states.

14. The apparatus as claimed in claim 1, wherein said rule system that processes the structural components is a rule system with both logical and numerical functions mapping the structural components to supporting sets.

15. The apparatus as claimed in claim 1, wherein said rule system that maps the state history to the output variables is a rule system with both logical and numerical functions mapping the state variables to the output variables which are described in claim 12.
